(19) United States
(12) Patent Application Publication
(10) Pub. No.: US 2006/0101010 A1
(43) Pub. Date: May 11, 2006

(54) System and method for transmitting data associated with user rights

(75) Inventors: Abdellatif Benjelloun Touimi, Trebeurden (FR); Michel Milhau, Cairon (FR)

Correspondence Address: YOUNG & THOMPSON, 745 SOUTH 23RD STREET, 2ND FLOOR, ARLINGTON, VA, 22202, US

(73) Assignee: France Telecom, Paris (FR)

(21) Appl. No.: 10/536,994

(22) PCT Filed: Oct. 29, 2003
(86) PCT No.: PCT/FR03/03229

§ 371 Date: May 31, 2005

(30) Foreign Application Priority Data
Nov. 29, 2002 (FR) 02/15084

(51) Int. Cl. G06F 17/30

(52) U.S. Cl. 707/4

(57) ABSTRACT

A system for accessing data (10) associated with user rights (12) for the data (10), expressed in a specific language for expressing rights, on at least one consultation station (4) including elements for recovering (14) user rights adapted to identify user rights expressed in one or more different languages for access to the data (10). The system is characterized in that it includes a unit (16) for adapting user rights associated with elements (18) for determining the specific language wherein the user rights (12) are expressed associated with the data (10), to elements (20; 78) for determining the language(s) expressing user rights identified by the elements (14) for recovery from the consultation station (4), and to elements (22) converting user rights (12) for converting the user rights (12) associated with the data (10).

The present invention relates to a method and to a system for accessing information associated with use rights.

Information such as multimedia, audio, video or text data, software, etc. is frequently associated with use rights in order to protect and monitor use of the information.

The rights concerned may be rights to read, render, copy, transfer and exchange, adapt, manage or configure the information, and so on.

Access to the information is conditioned by access to and interpretation of the rights associated with the information.

Thus a consultation station must include recovery means adapted to recognize use rights in order to be able to access information associated therewith and to use that information as a function of the content of those use rights.

Use rights may be expressed in various languages known as rights expression languages (REL), such as the extensible Rights Markup Language (XrML) or the Open Digital Rights Language (ODRL).

For example, each rights expression language has a structure defined by a semantic scheme into which terms from a specific dictionary are integrated in order to recognize and interpret use rights in terms of permissions to use information.

Use of the same structure with another dictionary, or any other modification of the form in which use rights are expressed, is treated as two languages.

Because there is more than one rights expression language, some information may be inaccessible to a consultation station merely because it uses recovery means that are not adapted to recognize the language in which the use rights are expressed.

For example, in the case of mobile consultation stations, specific requirements and constraints lead to the use of recovery means adapted to recognize a limited number of languages.

Access to information is therefore limited by the capacities of the recovery means of the consultation station, regardless of the content of the use rights.

The object of the present invention is to solve the above problem by defining a method and a system for access to information associated with use rights.

The invention therefore consists in a system for access to information associated with rights to use that information expressed in a particular rights expression language at a consultation station including use rights recovery means adapted to recognize use rights expressed in one or more different languages in order to access said information, which system is characterized in that it includes a use rights adaptation unit associated with means for determining said particular language in which said use rights associated with said information are expressed, with means for determining the one or more use rights expression languages recognized by said recovery means of said consultation station, and with use rights conversion means for converting the use rights associated with said information when expressed in a language that is not recognized by said recovery means of said consultation station between said particular language in which the use rights associated with the information are expressed and another language selected from the one or more languages recognized by said recovery means of the consultation station.

According to other features of the invention:

said means for determining the one or more rights expression languages recognized by said recovery means of said consultation station include an adaptation server comprising means for remotely interrogating the recovery means;

said means for determining the one or more rights expression languages recognized by said recovery means of said consultation station include means for declaring to said adaptation unit the one or more languages recognized by said recovery means;

said information and said associated use rights are stored in the same information server connected to said consultation station and to said adaptation unit via an information transfer network;

said information is stored on an information server and said use rights associated with the information are stored on a rights management server, said information server, said rights management server, said consultation station and said adaptation unit being interconnected via an information transfer network, and said information including information as to the location of said rights management server to enable said consultation station to interrogate said rights management server in order to receive the rights associated with said information;

the system includes a plurality of consultation stations connected to said information server through said information transfer network via a plurality of network nodes and a plurality of adaptation units integrated into each of the nodes connected directly to said consultation station;

said consultation station is connected to said adaptation unit via a mobile telecommunication network and an information transfer network, said networks are connected by a gateway including information conversion means adapted to convert the information between said mobile telecommunication network and said information transfer network;

said consultation station is mobile and said recovery means are adapted to recognize the DRMREL rights expression language;

said rights associated with said information to be sent are expressed in the MPEG-21 rights expression language.

The invention also consists in a method of access to information associated with rights to use that information expressed in a particular rights expression language at a consultation station including use rights recovery means adapted to recognize use rights expressed in one or more different languages in order to access said information, which method is characterized in that it includes:

a step of determining the expression language of said rights;

a step of determining the one or more use rights expression languages recognized by said recovery means of said consultation station;

a step of converting said use rights expressed in said particular language in which the use rights associated with the information to be transmitted are expressed into another language selected from the one or more languages recognized by said recovery means; and

a step of sending said converted rights to said consultation station.

The invention will be better understood on reading the following description, which is given by way of example only and with reference to the accompanying drawings, in which:

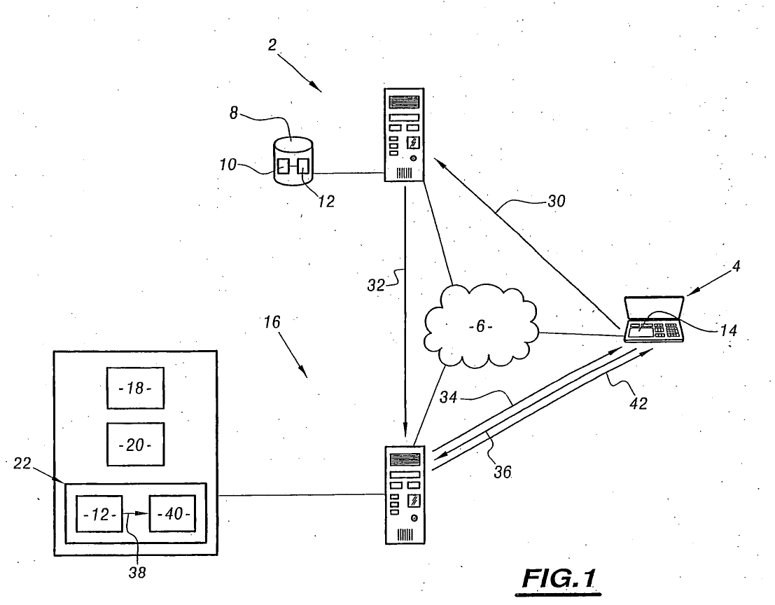

FIG. 1 is a block diagram of a system conforming to a first embodiment of the invention,

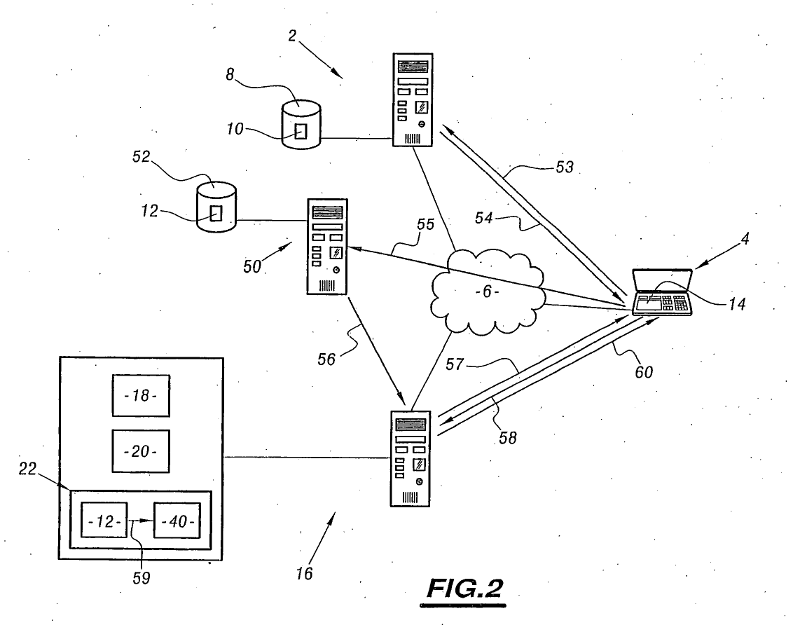

FIG. 2 is a block diagram of a system conforming to a second embodiment of the invention, and

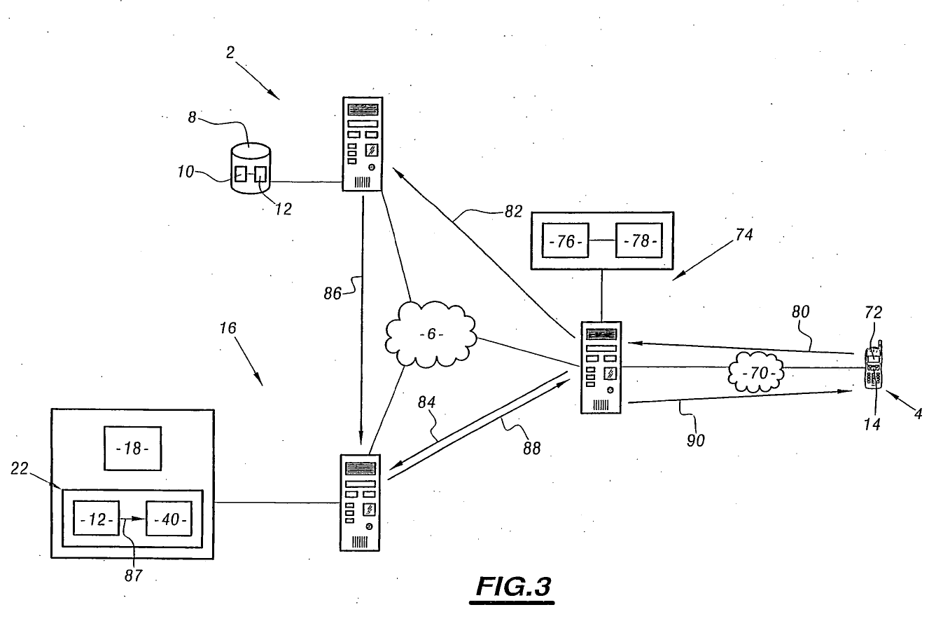

FIG. 3 is a block diagram of a system conforming to a third embodiment of the invention.

The system described with reference to FIG. 1 includes an information server 2 and a consultation station 4 interconnected by an information transfer network 6 such as the Internet or any other information transfer network.

In the conventional way, the information server 2 is connected to a database 8 containing information 10 associated with use rights 12.

Of course, the database 8 includes a plurality of sets of information such as the information 10, some or all of which sets of information are associated with use rights such as the use rights 12.

The use rights 12 are expressed in a particular language, for example the rights expression language (REL) defined in the MPEG-21 standard.

The various use rights associated with the various sets of information contained in the database 8 can of course be expressed in various languages.

In the conventional way, the consultation station 4 includes recovery means 14 adapted to recognize one or more use rights expression languages.

For example, the consultation station 4 might be a mobile terminal adapted to recognize a Digital Rights Management Rights Expression Language (DRMREL) as defined by the Open Mobile Alliance (OMA) forum.

According to the invention, the system further includes a use rights adaptation unit taking the form, in the present example, of an adaptation server 16 connected to the information transfer network 6.

The server 16 includes means 18 for determining the rights expression language 12 associated with the information 10. In the present embodiment, the means 18 include a module for sending/receiving information and use rights to/from the network 6 and a module for analyzing the rights expression format.

The server 16 also includes means 20 for interrogating a remote consultation station to determine the one or more use rights expression languages recognized by the consultation station 4, the means 20 forming means for determining the one or more languages recognized by the consultation station 4.

Finally, the server 16 includes means 22 for converting use rights between languages.

In the present embodiment, the use rights conversion means 22 are adapted to analyze rights expressed in a particular language and to extract the terms used corresponding to the dictionary associated with that language, assertions and links between those terms.

The terms and assertions are then each converted to form a structure corresponding to the expression of the same rights in the language selected for the conversion.

The means 18, 20 and 22 may be implemented in the form of independent application software or correspond to functions integrated into other data processing applications.

The operation of this kind of system is described next with reference to FIG. 1.

In a step 30, the consultation terminal 4 sends to the information server 2 a request to consult the information 10.

In a step 32, the information server 2 sends the information 10 and the associated use rights 12 to the adaptation server 16.

The information 10 and the data 12 are received by the send/receive module of the means 18, which then determine the language in which the rights 12 are expressed, by means of the analysis module.

In a step 34, the interrogation means 20 then interrogate the remote consultation station 14 in order to receive in return, in a step 36, a list of the rights expression languages that the recovery means 14 of the consultation station 4 recognize.

In the MPEG-21 standard there are provisions for exchange of information between a consultation station and a server for the purpose of determining the capacities of the station.

These exchanges of information are based on a signaling mechanism including information describing the capacities of the consultation station and in particular its capacities in terms of coding/decoding, input/output, network connection, etc., as defined in Part 7, “Digital Item Adaptation”, of the MPEG-21 standard.

In the context of the invention, it is necessary to add to the information relating to the capacities of the consultation station information describing its capacities in terms of rights expression languages, such information forming a list of the languages recognized.

Thus the information relating to the languages recognized is conveyed in “context Digital Item” (XDI) signaling messages defined in the MPEG-21 standard.

For example, the list of languages recognized is sent in the form of an XML file in which the data is structured in the form of a tree in order to form a list of languages and to define for each of those languages an identifier, an indication that it is recognized by the station 4, a priority order, and any other necessary information.

As described above, a plurality of dictionaries may be associated with the same language, recognition by the station 4 necessitating recognition of the language and recognition of the dictionary.

The adaptation server 16 then compares the particular language in which the use rights 12 associated with the information 10 to be sent are expressed and the languages recognized by the recovery means 14 of the consultation station 4.

If the particular language is recognized by the station 4, the server 16 sends the information 10 and the use rights 12 directly to the station 4.

Otherwise, in a step 38, the use rights 12 are converted by the conversion means 22 in order to express them in one of the languages recognized by the recovery means 14 of the consultation station 4 and to deliver the converted rights 40.

The language into which conversion is effected is selected by comparing the list of languages recognized by the station 4 and the capacities of the conversion means 22. If priority information is assigned to the various languages recognized by the station 4, that information is also taken into account to select a language from those recognized by the station 4 and usable by the conversion means 22. The language selected for the conversion is the language assigned the highest priority, for example.

In a step 42, the conversion having been effected, the information 10 and the converted use rights 40 are sent to the consultation station 4.

Thus the consultation station 4 receives the information 10 with the use rights 40 expressed in a language recognized by its recovery means 14, and access to the information 10 is allowed as a function of the nature of those rights.

A second embodiment of the invention is described next with reference to FIG. 2.

As in the preceding embodiment, this second embodiment of the system includes an information server 2 connected to a database 8 containing only the information 10.

The system further comprises a consultation station 4 including recovery means 14 and a use rights adaptation server 16 including means 18 for determining the rights expression language, interrogation means 20, and conversion means 22.

In this embodiment, the system further includes a use rights management server 50 also known as a licensed rights server.

The server 50 is connected to a database 52 including use rights and in particular use rights 12 associated with the information 10 and expressed in a particular language.

As before, the operation of this system begins with a step 53, similar to the step 30 described above, in which the consultation station 4 sends the information server 2 a request to access the information 10.

In this embodiment, in a step 54, the server 2 sends the information 10 directly to the station 4.

The information 10 received by the consultation station 4 is not accessible in its state at that time, and includes a pointer or a link indicating the location of the licensed rights server 50 managing the use rights 12 for the information 10.

In a step 55, the consultation station 4 interrogates the licensed rights server 50 in order to obtain the use rights 12 relating to the information 10.

During a step 56, the licensed rights server 50 sends the use rights to the adaptation server 16, which receives them via the means 18.

As in the steps 34 and 36 described above, the means 18 determine the language in which the rights 12 are expressed, after which, in a step 57, the means 20 interrogate the consultation station 4 in order to receive in return, in a step 58, a list of the languages recognized by the recovery means 14 of the consultation station 4.

In a step 59, similar to the step 38 described with reference to FIG. 1, the means 22 convert the use rights 12 expressed in the particular language into use rights 40 expressed in another language selected from the languages recognized by the recovery means 14.

Finally, during a step 60, the server 16 sends the consultation station 4 the converted use rights 40 expressed in a language recognized by the recovery means 14.

The station 4 can therefore access the information 20 and use it as a function of the associated rights 12.

A third embodiment of a system and a method of the invention is described next with reference to FIG. 3.

This figure shows an information server 2 associated with a database 8 including information 10 to be sent and associated rights 12, connected via the Internet 6 to an adaptation unit formed by a server 16 that includes only means 18 for determining the expression language of the rights 12 associated with the information 10 and conversion means 22.

In this embodiment, the receiver station 4 takes the form of a mobile telephone connected to a mobile telecommunication network 70 such as a GSM, GPRS, UMTS or other network comprising conventional means 72 for communication over the Internet 6 via the mobile telecommunication network 70.

To enable the exchange of information between the mobile telecommunication network 70 and the Internet 6, the system includes a communication gateway 74 conventionally including means 76 for converting and exchanging information between the mobile telecommunication network 70 and the Internet 6.

In the context of the invention, the gateway 74 also includes means 78 for declaring the one or more languages recognized by the recovery means 14 of the consultation station 4.

Accordingly, in operation, in a step 80, the consultation station sends a request, via the means 72, for example a mobile Internet request conforming to the Wireless Application Protocol (WAP).

That request is received by the gateway 74 and the means 76 convert the information contained in the request in order to send a request to the information server 2 via the Internet 6 in a step 82.

In parallel with this, in a step 84, the means 78 declare a list of the languages recognized by the recovery means 14 directly to the adaptation server 16. This list is determined by the known capacities of mobile terminals connected to the mobile telecommunication network 70, for example.

Accordingly, all mobile terminals connected to the mobile telecommunication network 70 are considered to have the same recovery means 14.

Alternatively, the declaration means 78 are adapted to identify the consultation station 4 and to access a database listing use rights languages recovery capacities for different consultation stations.

The declaration means 78 thus form means for determining the one or more languages recognized by the recovery means 14 of the consultation station 4.

In a step 86, the information server 2 then sends the adaptation server 16 the information 10 and the associated rights 12.

As in the step 38 described above, in a step 87, the means 22 convert the rights 12 between the particular language in which they are expressed and a rights expression language selected from those recognized by the consultation station 4.

Then, in a step 88, the server 16 sends the information 10 and the associated converted rights 40 to the gateway 74.

In this gateway, the means 76 convert the information in order to forward it to the consultation station 4 via the telecommunication network 70, in a step 90, to enable the station to access the information.

Alternatively, the adaptation server 16 may be connected to the mobile telecommunication network 70 rather than to the Internet 6. In that case, exchanges between the consultation station 4 and the adaptation server 16 are effected directly, whereas exchanges between the adaptation server 16 and the information server 2 are effected via the gateway 74.

It is therefore clear that the system and the method of the invention enable the transmission of information associated with use rights despite the use of different rights expression languages.

Of course, other configurations of the system may be envisaged.

In particular, systems such as those described can each manage a plurality of consultation stations of the same or different kinds.

In this kind of architecture, the information and the associated rights are sent by an information transmission server directly to a plurality of consultation stations.

In the conventional way, to avoid sending a large number of messages over the network, the information and the associated rights are sent between nodes of the network such as routers, gateways, servers, etc., and are duplicated by each last node in order to send an individual copy of the information and the associated rights to each consultation station.

This modes of operation is known as the “multicast” mode.

To enable efficient implementation of the invention in the above kind of system, it is necessary to integrate an adaptation unit into each last node of the network in order for exchange of information relating to the determination of the one or more languages recognized by each terminal to be limited to the last nodes of the network and the associated terminals.

The system of the invention may also be used in the case of “peer to peer” transmission of files between use stations.

In that kind of implementation, the information server, adaptation unit and receiver station functions are all implemented by use terminals, such as personal computers.

In a further variant, the information and the associated rights are stored on a consultation station that sends a request for conversion of the rights directly to the adaptation unit if it is not able to recognize them.

Alternatively, declaration means similar to those described with reference to FIG. 3 may be integrated directly into the consultation station and the list of languages recognized may be sent with the request to send information.

Moreover, the component parts of the use rights adaptation unit may be distributed differently between the entities of the system. Thus the adaptation unit may be integrated into the information server or into a gateway or a network node such as those described with reference to FIG. 3.

Alternatively, the component parts of the adaptation unit may be distributed between different entities of the system. For example, the conversion means may be integrated into another server and controlled remotely. In an embodiment of that kind, the rights are sent only to the conversion means, the means for determining the expression language used being adapted to be consulted remotely.

1-10. (canceled)

11. A system for accessing information associated with rights to use that information expressed in a particular rights expression language at a consultation station including use rights recovery means adapted to recognize use rights expressed in one or more different languages in order to access said information, which system includes a use rights adaptation unit associated with means for determining said particular language in which said use rights associated with said information are expressed, with means for determining the one or more use rights expression languages recognized by said recovery means of said consultation station, and with use rights conversion means for converting the use rights associated with said information when expressed in a language that is not recognized by said recovery means of said consultation station between said particular language in which the use rights associated with the information are expressed and another language selected from the one or more languages recognized by said recovery means of the consultation station.

12. A system according to claim 11, wherein said means for determining the one or more rights expression languages recognized by said recovery means of said consultation station include an adaptation server comprising means for remotely interrogating the recovery means.

13. A system according to claim 11, wherein said means for determining the one or more rights expression languages recognized by said recovery means of said consultation station include means for declaring to said adaptation unit the one or more languages recognized by said recovery means.

14. A system according to claim 11, wherein said information and said associated use rights are stored in the same information server connected to said consultation station and to said adaptation unit via an information transfer network.

15. A system according to claim 11, wherein said information is stored on an information server and said use rights associated with the information are stored on a rights management server, said information server, said rights management server, said consultation station and said adaptation unit being interconnected via an information transfer network, and said information including information as to the location of said rights management server to enable said consultation station to interrogate said rights management server in order to receive the rights associated with said information.

16. A system according to claim 14, including a plurality of consultation stations connected to said information server through said information transfer network via a plurality of network nodes and a plurality of adaptation units integrated into each of the nodes connected directly to said consultation station.

17. A system according to claim 11, wherein said consultation station is connected to said adaptation unit via a mobile telecommunication network and an information transfer network and said networks are connected by a gateway including information conversion means adapted to convert the information between said mobile telecommunication network and said information transfer network.

18. A system according to claim 11, wherein said consultation station is mobile and said recovery means are adapted to recognize the DRMREL rights expression language.

19. A system according to claim 18, wherein said rights associated with said information to be sent are expressed in the MPEG-21 rights expression language.

20. A method of accessing information associated with rights to use that information expressed in a particular rights expression language at a consultation station including use rights recovery means adapted to recognize use rights expressed in one or more different languages in order to access said information, which method includes:
a step of determining the expression language of said rights;
a step of determining the one or more use right expression languages recognized by said recovery means of said consultation station;
a step of converting said use rights expressed in said particular language in which the use rights associated with the information to be transmitted are expressed into another language selected from the one or more languages recognized by said recovery means; and
a step of sending said converted rights to said consultation station.
